(19) United States
(12) Patent Application Publication
(10) Pub. No.: US 2017/0103358 A1
(43) Pub. Date: Apr. 13, 2017

(54) SYSTEM FOR ELECTRONICALLY MANAGING AND ASSESSING COMPETENCY OF SKILLED WORKERS

(71) Applicant: Certa360 Limited, Devon (GB)

(72) Inventors: Warren H. Crook, Devon (GB); Richard C. Mintern, Beds (GB)

(21) Appl. No.: 15/292,378

(22) Filed: Oct. 13, 2016

Related U.S. Application Data
(60) Provisional application No. 62/240,739, filed on Oct. 13, 2015.

(51) Int. Cl. G06Q 10/06; G09B 7/00; G06F 17/30

(52) U.S. Cl. CPC G06Q 10/06393; G06F 17/30864; G09B 7/00

(57) ABSTRACT

A method and system to aid organizations in the compliance of new and existing statutory regulations and to set a new standard for risk based oversight control in regulated industries. The method and system provide a cloud based tool implementing a novel process and improving upon technologies for assessing competency levels of individuals responsible for performing particular tasks within an organization. The competency levels can be evaluated in view of regulatory requirements enforced upon the organization by statutory/competent authorities. The cloud based tool is designed to improve safety management through the determination of competency levels of individuals to perform particular tasks within an organization. The competency levels assist and enhance compliance with the regulatory standards, aid control mechanisms, reduce errors, and the associated financial losses incurred by the organizations caused by errors by individuals with insufficient competency levels performing particular tasks within an organization.

This application claims priority to, and the benefit of, co-pending U.S. Provisional Application No. 62/240,739, filed Oct. 13, 2015, for all subject matter common to both applications. The disclosure of said provisional application is hereby incorporated by reference in its entirety.

### FIELD OF THE INVENTION

The present invention relates to a system and corresponding method of use that enables users to digitally record their individual qualifications, training, and specific work experience in a manner that is suitable for organizations to transform the recordings into measurements and assessments of competency levels of the users in different fields and levels of activity. In particular, the present invention relates to competency requirements of staff for maintaining aircraft used in commercial air transport.

### BACKGROUND

Generally, countries and enforcement agencies often create statutory authority to be followed in industries that present inherent dangers. Typically the statutory authorities are created by government bodies to regulate and protect the public and civil interests. The Civil Aviation Authority (CAA) is one example of a government statutory authority in the United Kingdom (an equivalent is the Federal Aviation Administration (FAA) in the United States); the CAA oversees the regulation of civil aviation and individuals and companies involved in the civil aviation industry, due to the inherent dangers in the use of aircraft. In particular, the CAA is designed to regulate any involvement with aircraft design, manufacturing conditions and testing of aircraft and equipment, maintenance of aircraft, operation of aircraft and equipment, and licensing of pilots, maintenance engineers, airports, and navigational aids. Increased attention given by the CAA, as to how organizations such as airlines and maintenance organizations manage the competency of their staff, has been made more acute following the introduction of the new European Aviation Safety Agency (EASA) Air Operations Regulation implemented in 2012. Through both existing and new regulation, the CAA is taking a more centric view on what constitutes effective competence management systems and effectively redraws the boundaries to how organizations and the CAA must consider their processes for developing, maintaining, and monitoring the competence of all staff as it relates to the aviation industry. There is also the added complexity that CAA surveyors interpret the regulations differently, resulting in greater confusion and conflict with the organization being audited. Overall, the increased focus on competency by the EASA and CAA has opened the door to increased recognition of errors by humans when relying on conventional systems and increased audits to organizations.

The new regulations mean organizations must focus on better risk based control, clearer accountability of safety, better assessment of safety and performance of their engineering and non-engineering staff, improved auditing control, visibility, and ultimately ownership. Additionally, such regulatory change puts a greater emphasis on operators within the aviation industry to take ownership of their own safety management. One of the greatest risks that organizations and operators face stems from human error, specifically when there is a reliance on manual human record keeping and compliance review, in the maintenance and manufacturing arena. Increasingly complex technology and materials, increasing fleet size (requiring larger employee oversight), pressure on cost bases and free movement of engineering resources, make the need for risk-based oversight all the more acute, and further complicates the challenge of risk management and unassisted human organizing solutions.

Many organizations are trying to meet the new requirement using rudimentary and inadequate solutions, all of which are believed to result in increased demand for resources, costs, and time without any guarantee that these measures will meet existing and new regulations. Prior to the present invention, there is no tool that addresses these issues in a safe and controlled environment that enables oversight in a reliable, consistent, and efficient manner.

### SUMMARY

There is a need to aid organizations in the compliance of new and existing statutory regulations, as they pertain to competence, and to set a new standard by improving upon the technologies available for risk based oversight control in regulated industries. A solution is required to aid organizations in regulatory compliance while reducing reliance on human organizing activities that may lead to errors and inefficiencies. In particular, there is a need for a system that implements a new process not previously utilized to assess competency levels of staff maintaining aircraft used in commercial air transport, in such a way that eradicates uncertainty by delivering a universal and generic standard of comparison and therefore removing the differing opinions caused by the integral human involvement in the existing processes being employed by both the statutory regulators (e.g., CAA, FAA) and the organization(s) tasked with meeting the requirements of such regulators. The present invention is directed toward further solutions to address this need, in addition to having other desirable characteristics. Specifically, the present invention provides a technological improvement, through a unique combination of unconventional processing steps, in the form of a system for assessing and tracking competency of individuals on the basis of regulations enforced upon the organization by statutory authorities. By measuring competency levels with respect to regulation standards, the present invention contributes to improved safety across regulated industries by reducing errors and resulting added costs incurred by the organizations caused by errors by individuals within the organization.

In accordance with an example embodiment of the present invention, a method is provided. The method includes quantifying, using at least one processor, a competency level of the individual based on record data pertaining to the individual. The process of quantifying includes transforming relevant portions of the record data, using at least one processor, into a competence training and qualification level based on relevant training and qualification data for the individual for the particular task or position, and storing the competence training and qualification level. The process of quantifying also includes transforming relevant portions of the record data, using at least one processor, into a general competency level of the individual based on at least one predetermined industry standard data, and storing the general competency level. The process of quantifying further includes transforming relevant portions of the record data, using at least one processor, into an individual task competency level of the individual for the particular task or position based on the relevant training and qualification data of particular completed tasks performed by the individual. The process of quantifying also includes transforming relevant portions of the record data, using at least one processor, into a recency level based on duration and nature of experience data within a predetermined historical time period. The method also includes transforming, using at least one processor, the competence training and qualification level, the general competency level, the individual task competency level, and the recency level, into the competency scores of the individual. The method further includes outputting the competency scores of the individual in such a way that record data pertaining to an individual is transformed into output competency scores for the individual for a particular task, position, or job role.

In accordance with aspects of the present invention, the relevant training and qualification data includes details related to work history qualifications, training, and work experience of the individuals.

In accordance with aspects of the present invention, transforming the competence training and qualification level includes searching the record data of the individuals for specific qualifications and training certificates related to the particular task or position. A result of transforming the competence training and qualification level can include a pass or fail indication.

In accordance with aspects of the present invention, transforming the general competency level includes searching the record data and comparing aptitude and experience information over a period of time against a predetermined competency criteria. Transforming the general competency level further can include plotting a result of the searching and comparing against the at least one predetermined industry standard data to create a general competency score.

In accordance with aspects of the present invention, transforming the individual task competency level includes interrogating the record data for aptitude and experience information related to the particular task or position. A predetermined number of relevant training and qualification data related to the particular task or position can be plotted against an experience record scoring graph to create an individual task competency score.

In accordance with aspects of the present invention, transforming the recency level includes evaluating the duration and nature of aptitude and experience of the individuals based on the relevant training and qualification data.

In accordance with an example embodiment of the present invention, a system is provided. The system includes an input device configured to receive one or more profiles associated with the individuals, the one or more profiles including record data containing aptitude and experience information for the individuals. The system also includes a quantifying tool configured to determine a competency level of the individual based on the received one or more profiles. The process of quantifying includes a competence training and qualification assessment module configured to transform relevant portions of the record data into a competence training and qualification level based on relevant training and qualification data for the individual for the particular task or position, and storing the competence training and qualification level. The process of quantifying also includes a general competency module configured to transform relevant portions of the record data into a general competency level of the individual based on at least one predetermined industry standard data, and storing the general competency level. The process of quantifying further includes an individual task competency module configured to transform relevant portions of the record data into an individual task competency level of the individual for the particular task or position based on the relevant training and qualification data of particular completed tasks performed by the individual. The process of quantifying also includes a recency module configured to transform relevant portions of the record data into a recency level based on duration and nature of experience data within a predetermined historical time period. The system further includes the quantifying tool transforming the competence training and qualification level, the general competency level, the individual task competency level, and the recency level, into the competency scores of the individual. The system also includes a display device configured to output the competency scores of the individual.

In accordance with aspects of the present invention, the relevant training and qualification data includes details related to work history qualifications, training, and work experience of the individuals.

In accordance with aspects of the present invention, transforming the competence training and qualification level includes searching the one or more profiles of the individuals for specific qualifications and training certificates related to the particular task or position. A result of transforming the competence training and qualification level can include a pass or fail indication.

In accordance with aspects of the present invention, transforming the general competency level includes searching the one or more profiles and comparing aptitude and validated electronic logbook experience information over a period of time against a predetermined competency criteria. Transforming the general competency level further can also include plotting a result of the searching and comparing against the at least one predetermined industry standard data to create a general competency score.

In accordance with aspects of the present invention, transforming the individual task competency level includes interrogating the one or more profiles for aptitude validated electronic logbook and experience information related to the particular task or position. A predetermined number of relevant training and qualification data related to the particular competency, task, position, or job role can be plotted against an experience record scoring graph to create an individual task competency score. Information in the one or more profiles can be validated by a user that has been granted the relevant privileges and/or permissions. The experience information can be validated, when a user uploads experience record data, by selecting a validator that has been granted the relevant privileges and/or permissions.

In accordance with aspects of the present invention, transforming the recency level includes evaluating the duration, nature, and frequency of validated electronic logbook experience of the individuals based on the industry standard requirement data.

### BRIEF DESCRIPTION OF THE FIGURES

These and other characteristics of the present invention will be more fully understood by reference to the following detailed description in conjunction with the attached drawings, in which:

FIG. 1 is an illustrative environment for implementing the steps in accordance with the aspects of the invention;

FIG. 2 is an illustrative user interface for populating experience records in accordance with the aspects of the invention;

FIG. 3 is an exemplary flow chart showing the steps of implementing the system in accordance with the aspects of the invention; and

FIG. 4 is a diagrammatic illustration of a high level architecture for implementing processes in accordance with aspects of the invention.

### DETAILED DESCRIPTION

An illustrative embodiment of the present invention relates to a cloud based system that utilizes a range of complex algorithms and logic to transform information data (such as logbook data) for individual skilled workers, such as engineers and non-engineers with specialty training, into quantifiable competency levels for use by an organization or a regulatory body. The quantifiable competency levels are provided in a manner that improves upon existing technology for managing qualified competency for individuals and employees to perform certain tasks or job positions, e.g., aircraft maintenance services. Specifically, the present invention collects and records a range of data provided by individual users including their training, qualifications, and work experience records to create validated experience records/profiles for each of the individual users. All of this information data recorded in the experience records/profiles is then transformed to provide an accurate and quantified indication of competency in relation to a particular job role or activity to be undertaken, improving upon prior technologies for managing such processes. Visibility of this information enables organizations to build more rigorous and reliable assessment of the competence of their workforce, creating opportunities to improve efficiency, safety, compliance with the regulations, standards, control, and the overall quality of the operations within the organization. In other words, the system enables users to create a profile to record their qualifications, training, and work experience information in a manner suitable for organizations to transform that information data into measurements and assessments of competency levels, and then output reports that communicate quantifiable competency levels of individual users in different fields and levels of activity.

With this improved technology, organizations can access the information recorded in the system and generate reports on the competency levels of individual users in different fields and levels of activities, based on the digitally recorded training qualifications and relevant work experience information data. The analysis by the system utilizes a range of unconventional process steps implemented by specific complex algorithms and logic uniquely suited to the assessment of competency to evaluate competence levels of an individual or group of individuals. Additionally, this analysis is carried out in line with statutory regulations related to a particular industry (e.g., regulations from the EASA or the FAA for the aviation industry). In other words, the system performs analyses that transform individuals' digitally recorded information data into competency levels related to maintenance, manufacturing, and operational activities within a particular fields of expertise (e.g., aviation, aerospace, etc.). In doing so, the system provides dramatically improved and consistent control and oversight of competency and compliance of users performing activities in accordance with the regulations of the industry.

Competency, as described herein, can be a measurable and quantifiable skill or standard of performance, knowledge, and understanding while taking into consideration attitude and behavior. In particular, competency can include a cluster of related abilities, commitments, knowledge and skills that enables an individual or an organization to act effectively in a job or situation. Competence also indicates sufficiency of knowledge and skills that enable an individual to act in a wide variety of situations. Competency levels of individuals can be assessed, using the system, by evaluating an individual's profile (and the data included therein) using modules and tools specifically designed for transforming general information data of individuals into quantifiable measures of competence training and qualification assessment, individual task competency, and general competency, as they compare against defined regulations. Based on the transformation of the individual's profile data (i.e., digitally recorded information data) a competency indication or score can be assigned to that individual. The competency indication or score can reflect an overall level of competency for the individual performing a particular task and/or fill a particular position in a particular field (e.g., an engineer responsible for performing maintenance on a particular aircraft). The system enables organizations to monitor and manage their engineer and non-engineering personnel, carrying out comprehensive competency evaluations and assessments to ensure that teams are deployed effectively and that all technical staff are suitably skilled and qualified to be carrying out their roles. The system also increases the level of oversight and reduces the level of human subjectivity in such evaluations.

The system provides benefits for a variety of different user bases. For example, the system can be customized for utilization by individual users (e.g., prospective employees, current employees, etc.), employers/organizations, and regulatory agencies for different purposes. For individual users, the system provides a platform to store, organize, and showcase materials including details related to skill sets, work experience, and credentials. The information managed by the system, for individuals, is implemented in a fashion that exceeds the capacity of a traditional curriculum vitae or resume and provides qualified individuals with greater exposure to employers (e.g., organizations) seeking potential job candidates with qualifications matching their respective work experience and credentials.

Similarly, organizations can utilize the system to form connections with individual users and view the work related data that the individuals have digitally stored within the system. In particular, the organizations can use the system to review competency information related to individuals currently working within the organization, identify missing skillsets in employee positions, and/or to seek out individual candidates to fill a particular position or skillset within the organization. Accordingly, organizations can also utilize the system to evaluate the competency levels of current employees and/or individual users that are prospective employees. The system enables organizations to efficiently plan, manage, record, and monitor the competence of all engineering and non-engineering staff both employed and contract/temporary staff within their business without the need for any expensive additional equipment or technology. Additionally, the system provides a mechanism for organizations to monitor day to day activities performed by individuals to ensure that these activities are being performed in accordance with regulatory standards and by qualified personnel. The system also provides organizations with real time oversight capability with certification and validation of individual user records in a single application. The system provides an electronic logbook of validated individual user records, enabling significantly enhanced risk-based oversight capability. This ensures that safety risks are minimized and improved autonomy is provided in support of the performance of the safety management system to better manage the risk. Furthermore, the system instills management confidence, reduces costs associated with performing employee audits using traditional methods, and reduce the frequency and severity of incidents and accidents caused by lack of competence to perform a given task.

Furthermore, the system provides regulatory bodies, such as the CAA or FAA, with a tool that enables a real time auditing capability of organizations and individuals to ensure that the organizations and/or individuals are in compliance with regulatory guidelines at any given point in time. In particular, the system provides a compliance monitoring tool that enables the CAA or FAA to perform remote electronic auditing and planning prior to undertaking physical auditing of an organization. The advanced electronic audit planning enables the CAA or FAA to identify particular needs and allocate resources to key areas of auditing focus, such that auditing resources are deployed more efficiently. Additionally, the system provides the CAA or FAA with a tool to enable the agencies to remotely monitor and measure competency across all aspects of work activity within one or more organizations at any given point in time (e.g., without having to perform an in-person audit). Accordingly, the system offers the CAA or FAA a universal and controlled risk based measurement to monitor and audit engineer and non-engineer compliance and competency.

As would be appreciated by one skilled in the art, the system can be tailored for particular industries and areas of interest, levels of training and qualifications, regulatory standards, and other categories. For example, within the aircraft maintenance industry, aircraft are maintained in accordance with a structure of chapters known as the Air Transport Association (ATA) chapter standard or Federal Aviation Regulations (FAR). Thus, for the aviation industry, the system can be designed to measure competency requirements against ATA or FAR chapters, as defined by CAA or FAA regulations for maintaining aircraft used in commercial air transportation. The ATA standard is universally recognized as the standard in the aviation sector as the structure of information relating to maintenance requirements, procedures, aircraft configuration controls and flight operations. Accordingly, the reporting algorithms of the system application are designed and built around the chapter structure of the ATA, making it unique to the aviation field. Although for purposes of this disclosure the present invention is described with a focus on the aviation industry, such focus on aviation is merely for explanation purposes only and is not intended to limit the present invention to the aviation industry, as would be appreciated by those of skill in the art.

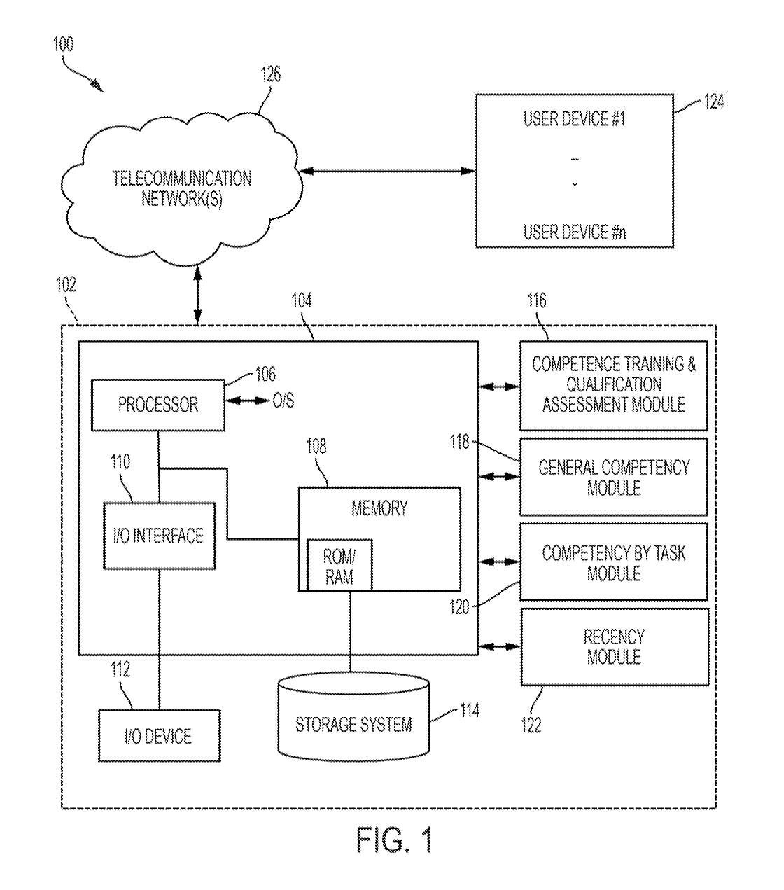

FIGS. 1 through 4, wherein like parts are designated by like reference numerals throughout, illustrate an example embodiment or embodiments of utilizing a system to transform digitally recorded information data concerning an individual's qualifications, training, and specific work experience into a quantifiable measure of competency level of the individual, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an illustrative system for implementing the steps in accordance with the aspects of the invention. In particular, FIG. 1 depicts a system 100 including a management system 102. In accordance with an example embodiment, the system 102 is a web based computing infrastructure providing a comprehensive tool for recording, evaluating, and managing the competency of employees or potential employees for a particular industry. For example, system 102 can be a cloud based application designed to record, evaluate, and manage the competency of engineers and non-engineers performing tasks (e.g., maintenance, inspection, testing, supervising, etc.) in the aviation industry.

The system 102 can include a computing device 104 having a processor 106, a memory 108, an input output interface 110, input and output devices 112, and a storage system 114. As would be appreciated by one skilled in the art, the computing device 104 can include a single computing device, a collection of computing devices in a network computing system, a cloud computing infrastructure, or a combination thereof. Similarly, as would be appreciated by one of skill in the art, the storage system 114 can include any combination of computing devices configured to store and organize a collection of data. For example, storage system 114 can be a local storage device on the computing device 104, a remote database facility, or a cloud computing storage environment. The storage system 114 can also include a database management system utilizing a given database model configured to interact with a user for analyzing the database data.

Continuing with FIG. 1, the system 102 can include a combination of core modules or tools configured to carry out the various functions of the present invention. In accordance with an example embodiment of the present invention, the system 102 includes competence training and qualification assessment module 116, a general competency module 118, a competency by task module 120, and a recency module 122. The competence training and qualification assessment module 116, the general competency module 118, the competency by task module 120, and the recency module 122 are used to evaluate and determine a competency level for one or more individuals for performing a particular task, job, position, etc.

In accordance with an example embodiment of the present invention, the competence training and qualification assessment module 116 provides visibility and a centralized record of an individual's training, qualifications and certification that can be evaluated against a pre-determined requirement (e.g., regulatory requirements or standards). The competence training and qualification assessment module 116 provides users access to the system 102 to create and update profiles including work experience, training, certifications and upload documentation to supplement that information. The profiles capture all of the relevant personal data for an individual user and specific competencies required for that individual user as defined for the job role of the individual user (and as identified by the competence training and qualification assessment module 116). Accordingly, the profile data forms the basis of the competence training and qualification assessment module 116. Additionally, the competence training and qualification assessment module 116 can be configured to produce a graphical user interface (GUI) for receiving input of the data within the user profiles as well as displaying the profiles and data included therein.

In accordance with an example embodiment of the present invention, the general competency module 118 is configured to maintain experience records for individual users in an electronic logbook. The experience records include validations associated therewith, as discussed with respect to the profiles. For example, the experience records for a particular job role can have a particular validation associated therewith, such that a validation for an experience record of an individual in that job role can be properly verified. The electronic logbook and experience records forms the basis for validation of competency for any given individual, task, job role, etc. such that it can be utilized by a combination of the general competency module 118, the competency by task module 120, and the recency module 122.

In accordance with an example embodiment of the present invention, the general competency module 118 is also configured to evaluate validated user submitted experience and activity records (e.g., experience records) against particular job positions, functions, tasks, events, etc. In particular, the general competency module 118 is configured to evaluate validated user submitted experience and activity records against particular activity types, maintenance types, maintenance object types, and information standards for maintenance. For example, in the aviation industry, the general competency module 118 can transform an individual's specific validated experience and activity records (e.g., recorded and managed by the competence training and qualification assessment module 116) related to specific aircraft activity types, aircraft maintenance types, aircraft types, and information standards for aviation maintenance published by Airlines for America (e.g., the ATA iSpec2200 methodology (ATA2200)) into a quantifiable general competency measure or level according to the ATA2200 standards. Additionally, in accordance with an example embodiment of the present invention, the general competency module 118 can implement the transformation of the validated experience and activity records using a predetermined preceding period of time of the validated experience records to evaluate competency based on recent experience(s). For example, the general competency module 118 can select experience and activity records for a preceding five-year period of time, and transform that data into a general competency measure or level for that period of time.

Similar to the general competency module 118, in accordance with an example embodiment of the present invention, the competency by task module 120 is configured to transform an individual's specific experience and activity records (e.g., recorded and managed by the competence training and qualification assessment module 116) for specific activity types, maintenance types, maintenance object types, and information standards for maintenance, into a quantifiable competence by task measure or level based on task completion. For example, in the aviation industry, the competency by task module 120 can transform an individual's specific experience and activity records related to specific aircraft activity types, aircraft maintenance types, aircraft types and the ATA iSpec 2200 chapter, sub-chapter and subject methodology, into a quantifiable general competency measure or level based on specific task completion. Additionally, the competency by task module 120 can implement the transformation of experience and activity records over a predetermined preceding period of time of the experience records to evaluate competency based on recent experience(s). For example, the competency by task module 120 can evaluate select experience and activity records for a preceding two-year period of time of experience records, and transform that data into a general competency measure or level for that period of time.

In accordance with an example embodiment of the present invention, the recency module 122 is configured to transform an individual's specific experience records for a predetermined period of time into a quantifiable measure or level of recency. For example, as applied in the aircraft industry, the recency module 122 can transform an individual's specific experience over a preceding two-year period of time as required to demonstrate compliance with the European Aviation Safety Agency (EASA Part 66) regulation standards of certifying staff in aircraft maintenance (e.g., as part of commission regulation (EU) No. 1321/2014 Annex III part 66 certifying staff) into a quantifiable measure or level of recency for the data being reviewed. The recency module 122 can also transform data related to whether a certain number of tasks have been completed by an individual within a specific period of time (e.g., six months), in accordance with regulatory standards, into a quantifiable measure or level of recency.

In accordance with an example embodiment of the present invention, the system 102 includes additional modules and tools for transforming information managed by the system 102 and the storage system 114. The other modules can include, but are not limited to a behavior and practical assessment module, a personnel assessment module, and a competency builder module (not depicted but included within the system 102 and the storage system 114). The behavior and practical assessment module can enable organizations to carry out an assessment of individual users against a standardized set of observational measures including oral, written and practical. The personnel assessment module can allow organizations to measure individual users against set benchmarks, achievement levels and observations related to individuals and the performance of their duties. The competency builder module can enable the organizations to create their own competency measurements that can be applied by the system 102. Furthermore, the competency builder module provides organizations with a significant amount of flexibility and scalability to meet the needs of their competency requirements.

In accordance with an example embodiment of the present invention, the system 100 includes a plurality of user devices 124 configured to communicate with the system 102 over a telecommunication network(s) 126. As would be appreciated by one skilled in the art, the plurality of user devices 124 can include any combination of computing devices, as described with respect to the system 102 computing device. For example, the plurality of user devices 124 can include personal computers, laptops, tablets, smartphones, etc. In accordance with an example embodiment of the present invention, the computing devices 104, 124 are configured to establish a connection and communicate over telecommunication network(s) 126 to carry out aspects of the present invention. As would be appreciated by one skilled in the art, the telecommunication network(s) 126 can include any combination of known networks. For example, the telecommunication network(s) 126 may be combination of a mobile network, WAN, LAN, or other type of network. The telecommunication network(s) 126 can be used to exchange data between the computing devices 104, 124, exchange data with the storage system 114, and/or to collect data from additional sources.

In operation, the system 100 provides a system and method for evaluating competency of individuals for a particular task and/or position in accordance with the present invention. In particular, the system 102 of system 100 uses the modules 116, 118, 120, 122 to transform profile information data recorded for individuals into quantifiable measures or levels of competency for each individual. Initially, the system 102 constructs a database (e.g., on the storage system 114) including the training, qualifications, and work experience records or profiles for each individual to be evaluated for competency. For example, the training, qualifications and work experience records for engineers and non-engineers can be stored and maintained within a database on the storage system 114. Additionally, the system 102 provides individual users with the ability to add data to the experience record profiles by building and sharing digital curriculum vitae (CV) and logbook, thus reducing the need to supply large quantities of paperwork for job application, quality boards, and recruiters.

In accordance with an example embodiment of the present invention, individual users securely login to the system 102 (e.g., using user device(s) 124), utilizing any combination of systems and methods known in the art (e.g., through a web portal, using a mobile application, etc.), and create and/or update their experience record or profile with their work history information. For example, individual users can access the system 102 and the storage system 114 logging into a webpage or web portal over the telecommunication network(s) 126 using a user device 124 and enter the appropriate experience data into their profile. Each individual user is associated with a unique profile with user specified login credentials and the profile is identified in the system 102 using a unique identifier. Once a user is logged into their account, they can create, update, and revise their experience record and profile with information data as needed. As would be appreciated by one skilled in the art, the users can enter the experience data into their experience record and profile manually (e.g., using a combination of text fields, drop down menus, etc. in a GUI) or the user can upload documents (e.g., certifications, CVs, etc.) which can be used by the system 102 to automatically populate data into the user's experience record (optical character recognition). Additionally, the qualification and training records can be populated by a combination of users within an organization updating data within profiles for existing employees and/or by individual users creating and/or updating their own profiles. The combination of the entered and upload information can act as an electronic or virtual logbook for all the tasks, experience, etc. that the user has achieved over a predetermined period of time. In particular, the records provide a historical record for all experience, training, etc. obtained by the individual.

Each individual user within or outside an organization has their own respective account with a validated experience record and profile of digitally recorded information data stored in the database (e.g., the storage system 114) for system 102. For companywide coverage of all employees, organizations can require that each employee have their own account with an up to date experience record and profile. The validated experience records and profiles include a complete history of experience gained by the associated individual user over their working career and are organized in a standardized format for use by the system 102. In accordance with an example embodiment of the present invention, the individual users enter work experience into the system 102 in the form of tasks (e.g., via a GUI on the user device 124). The tasks can require a user to specify and input an exact nature of the work that the user has carried out by using standard terms of reference established by system 102. The standard terms of reference include details such as the environment in which the task has been carried out, the type of activity undertaken, levels of certification achieved, ATA chapter number, etc.

In accordance with an example embodiment of the present invention, the experience record includes details of each specific validated task(s) that has been performed throughout a work history of the user. For example, the task details can include dates, duration of hours, the organization that the task was performed under, a type of object being worked on (e.g., type of aircraft), registration information for the object, a job number, type of maintenance, type of activity (e.g., performed the task, supervised the task, etc.), job title, relevant standard (e.g., relevant ATA chapter, sub-chapter and subject), summary of the task, etc. The task can also include industry specific details or standards particular to specific regulations for that industry. For example, in the aviation industry, the task details can include an aircraft type, activity type, engines and component type undertaken using the Air Transport Association (ATA) chapter index classification structure. The ATA chapter index provides standard specifications relating to maintenance requirements, procedures, aircraft configuration controls and flight operations.

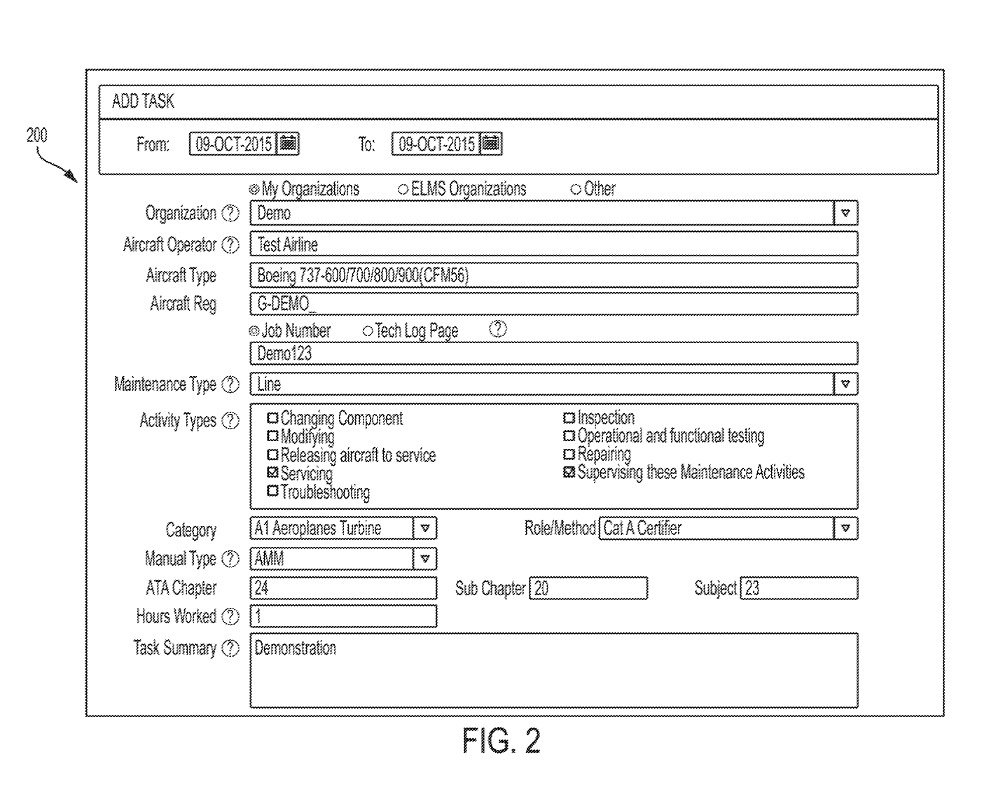

In accordance with an example embodiment of the present invention, to create experience record entries in a standardized format, the tasks recorded in the experience record are recorded against a standardized activity type. The activity types can include any activities or tasks that are considered to be relevant to a particular regulated field or industry. For example, the activity types can include servicing, inspection, operational and functional testing, troubleshooting, repairing, modifying, changing components, supervising, and releasing an object to service. Accordingly, if a recorded task associated with a given activity type is missing information from the standardized format, then the user will be prompted requesting the missing information. As would be appreciated by one skilled in the art, the system 102 can present the user with a predefined graphical user interface including sections and/or fields prompting the user to enter particular types of information. For example, the system 102 can include a section for types of aircraft that users may have worked on and can include fields related to certifications, number of tasks completed, details about each task completed etc. to be filled out for each indicated and/or selected type of aircraft. An example depiction of the predefined user interface for is depicted in FIG. 2.

In particular, FIG. 2 depicts an example implementation of a user interface 200 that can be utilized by a user to populate events or tasks into an individual's experience record. The representative user interface 200 depicted in FIG. 2 includes fields for Organization (Name) 210, Aircraft Operator 212, Aircraft Type 214, Aircraft Registration number 216, Job Number/TechLog Page 218, Maintenance Type 220, Activity Types 222, Category 224, Role/Method 226, Manual Type 228, ATA Chapter 230, Sub Chapter 232, Subject 234, Hours Worked 236, and Task Summary 238. As would be appreciated by one skilled in the art, the user interface 200 can also include predetermined options to select from via a combination of text fields, drop boxes, check boxes, combo boxes, etc. based on the type of information being requested/entered and a number of available options for that information. For example, as shown in FIG. 2, the Activity Types 222 field includes multiple check boxes for sub-categories (changing component, modifying, releasing aircraft to service, servicing, troubleshooting, inspection, operational and functional testing, repairing, and supervising these maintenance activities) and the Organization 210, Maintenance Type 220, Category 224, Role/Method 226, and Manual Type 228 fields include drop down boxes. In accordance with an example embodiment of the present invention, the user interface 200 also includes an attachment interface for uploading documents (not depicted). As would be appreciated by one skilled in the art, any documents can be uploaded via the attachment interface and used by the system 102 to populate data within the experience records (e.g., using OCR or other technologies known in the art). Accordingly, individuals can utilize the user interface 200, or a similar user interface, to add tasks or events to their respective experience records (e.g., profiles).

In accordance with an example embodiment of the present invention, the system 102 performs a validation process on all information stored in the user profiles and experience records. The validation process includes differentiating the way in which the data is used in the system 102, compared to exiting and traditional uses of the data types. In particular, the validation process has two parts, the first part is the validation of the profile data and the second part is the validation of the experience record data. For validation of the profile data, a user that has been granted the relevant privileges/permissions, by an organization through the competence training and qualification assessment module 116, performs a verification of the relevant profile of competency items. For validation of the experience record data, when a user uploads experience record data into the system 102 (e.g., in accordance with the example interface provided in FIG. 2) the uploading user selects a validator. The selected validator verifies that the experience record being uploaded was uploaded and completed by the relevant user in accordance with the criteria entered into the example interface provided in FIG. 2. The available validators are assigned by the respective organization; however the system 102 has been created with algorithms that ensure that only those validators with the required/specific job role (e.g., a superior to an uploading user) can validate experience records submitted/uploaded by users with the specific job roles. This allows an element of advanced control versus traditional methods of validating this type of data, thus ensuring the quality of the data submitted and the confidence in the users and their respective organizations.

In accordance with an example embodiment of the present invention, the system 102 captures additional information about individuals outside of data fields provided in FIG. 2. In particular, the additional information includes, but is not limited to, dates of relevant experience and/or training, durations of relevant experience and/or training, organizations that the individual belongs or has employment history, aircraft type, aircraft registration, job number techlog number, types of maintenance, type of maintenance activity, job role, category classifications (e.g., EASA Part66 license categories: A, B1, B2, B3, or C), relevant ATA chapters, and task summary of operations performed. Using the information data populated in the experience records, the various modules in system 102 can use the entered, uploaded, and otherwise acquired information data to perform the competency evaluations. As would be appreciated by one skilled in the art, when a user is entering data into the experience records for a particular task that was performed or a particular type of experience, each of the fields within the user interface (e.g., interface as depicted in FIG. 2) will include different information data to be stored in the system 102. Accordingly, for each experience record entered into the system 102 interface, a new record will be associated with that user in the database (e.g., the user's experience record).

Continuing with FIG. 1, in accordance with an example embodiment of the present invention, the system 102 and storage system 114 can be updated to include all the documentation necessary to define the regulatory rules and standards required by the governing body. For example, in the aviation industry, the ATA2200 chapter index of chapters, sub chapters, and events are uploaded and stored within the storage system 114. Additionally, the storage system 114 can include an index in which each function (e.g., job position, job function, activity, task, etc.) is associated with the relevant ATA2200 chapter(s) required to satisfy competency for completing those functions. These indices allow for a three stage hierarchy to provide greater level of specificity by chapter, sub-chapter and event. The ATA2200 chapter is a common referencing standard for all commercial aircraft documentation and can be used to compare to the profiles for the individual users to ensure they meet the standards outlined in the EASA regulations when performing particular job operations or tasks. In one example, if a particular user is being tasked with a particular activity, their experience and credentials from their profile will be compared against the relevant chapter(s) of the ATA2200 chapter associated with the particular activity to see if that user meets the required standards set forth by the regulatory body.

In accordance with an example embodiment of the present invention, using the profiles and experience records stored in the storage system 114 of the system 102, organizations and regulatory authorities can access the data and transform that data into quantifiable levels of competency for individuals associated with the profiles (as it pertains to performing certain functions). For example, user device(s) 124 can be used by users at the organizations and regulatory authorities to access the information in the system 102 to obtain the competency information for individuals for various functions. The levels of competency can be measured through different metrics by performing a competence training and qualification assessment, an individual task competency evaluation, general competency evaluation, and recency evaluation.

In accordance with an example embodiment of the present invention, the competence training and qualification assessment is carried out by the competence training and qualification assessment module 116. The information produced by the competence training and qualification assessment module 116 can be used by organizations for quality board appraisals, references, mandatory training, record of training, and qualifications. Additionally, the competence training and qualification assessment module 116 can check certificates associated with individuals with their respective expiration dates, validate against the recorded dates, uploaded references, initial organization assessment, and perform ongoing assessment.

In accordance with an example embodiment of the present invention, the competence training and qualification assessment module 116 searches the profile for stored training, qualifications, and specific competency information data. Upon identification of any training, qualification and specific competency records, the competence training and qualification assessment module 116 can check for existing copies/records of specific qualifications, training certificates, and/or competency records within the profile matching a particular job role category. The criteria job role category can be defined by the organization or regulatory authority. For example, if a particular maintenance job requires a particular qualification (e.g., according the CAA or FAA) then the profile can be searched for that particular qualification to evaluate whether an individual is competent to perform that particular maintenance job. Additionally, the competence training and qualification assessment module 116 can verify whether the identified certificates are valid and up to date. For example, all certificates with expiration dates will be checked for validity against the recorded dates and the current date. This enables organizations an efficient system for maintaining certifications and identifying any individuals who may need to renew an expired or soon to be expired certification.

In accordance with an example embodiment of the present invention, the competence training and qualification assessment module 116 also checks whether an assessment of the recorded and uploaded references within the profile for employees has been carried out by the organization (e.g., induction or on-the-job assessment. Additionally, there can be a requirement on the approved organization to carry out an initial and an ongoing periodic assessment of all personnel when initially employed in a position, which can be tracked by the competence training and qualification assessment module 116. As would be appreciated by one skilled in the art, the format and content of this assessment is left to the individual approved organization, but there can be particular requirements for completing these assessments (e.g., by regulatory bodies). For example, organizations can be required to maintain a record of the assessments that have been performed on individuals. Accordingly, the assessments can be recorded in the system 102 and stored for access by the organization and regulatory agencies. As would be appreciated by one skilled in the art, the assessments can be accessed and manually entered into the system 102 (e.g., using a Graphical User Interface (GUI)), the documentation for the assessment can be uploaded, and/or can be recorded using other methods known in the art. Once recorded, the assessments can be checked for completion by the competence training and qualification assessment module 116 to ensure a complete record of the assessment has been created including when the assessments need to be accessed and/or reviewed at a future date. As would be appreciated by one skilled in the art, the searching and comparison functions performed by the competence training and qualification assessment module 116 can be executed utilizing any combination of methods or systems known in the art.

In accordance with an example embodiment of the present invention, the competence training and qualification assessment module 116 is used to initiate and perform periodic assessments over a given period of time. For example, the competence training and qualification assessment module 116 can perform ongoing continuous assessments of individual experience records dating back over, e.g., a two-year period. As would be appreciated by one skilled in the art, the frequency of the assessments can be adjustable by organizations and/or regulatory agencies to fit within their procedures. On completion of an assessment or evaluation by the competence training and qualification assessment module 116 a user (e.g., an assessor) is provided with a simple pass or fail indication (e.g., through the GUI) and the indication is stored in the system 102. Additionally, when an evaluation results in a fail indication, the details of the findings will be displayed, and the authorized user can have the ability to override the failure indication and record the override and reason for the override in the system 102. In particular, in the case of an override, an explanation for the reason for the override can be entered into an attached text box. Similarly, the authorized user carrying out the report will be able to view all documents uploaded and, if required, the user will also be able to reject any documents that have been uploaded incorrectly or falsely. In this instance, the authorized user can enter a description of the reason for the rejection in the system 102 (e.g., via a text box in the GUI). Additionally, the competence training and qualification assessment module 116 can generate an automatic notification to an administrative user with an indication to correct the failed document as required.

In accordance with an example embodiment of the present invention, a general competency module 118 is used to evaluate an individual's general level of competency to perform given tasks. In particular, the general competency module 118 can interrogate experience records over a predetermined preceding period of time to identify events performed in accordance with particular regulatory standards (e.g., meet the standards outlined in the ATA Chapters). The events can be tasks recorded in the experience record for the individuals/employees that match a predetermined criteria associated with a particular task, particular job or position that is being evaluated for competency. For example, when evaluating a competency level for a maintenance type (e.g., line maintenance, maintenance on an aircraft type, a maintenance activity type, or a combination of all maintenance types), the general competency module 118 can interrogate experience records, for the events matching the predetermined criteria associated with the maintenance types, over the preceding five-year period. As would be appreciated by one skilled in the art, the interrogating and comparison functions performed by the general competency module 118 can be executed utilizing any combination of methods or systems known in the art.

After identifying the specific competency, the information data gathered from the tasks matching the predetermined criteria is transformed into the desired competency measure. More specifically, the general competency module 118 can plot the gathered information data against the relevant regulatory standard(s) for organizations in the industry (e.g., EASA Part 145 personnel competency requirements) associated with the particular task, particular job or position that is being evaluated. As would be appreciated by one skilled in the art, the system 102 can maintain a database of the relevant regulatory standard(s) that are associated with particular task, particular job or position being evaluated by the general competency module 118. In accordance with an example embodiment of the present invention, each identified occurrence of a task that is matched with a regulatory section will be tallied and stored in the storage system 114 for a resulting overall value. In other words, the general competency module 118 tallies a number of times a task matching a regulatory standard is found in an experience record for an individual. For example, as illustrated using the European aviation regulation, the general competency module 118 can plot the tasks from an experience record against the Relevant ATA2200 Chapters, as shown in TABLE 1. Using the plotted information, the general competency module 118 can identify a number of identified tasks or events per ATA2200 chapter and organize the events by job role to get a percentage value.

TABLE 1

| | ATA Chapters Required | | | | | | | | | | | | | | | | | | | | |
|---|---|---|---|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 | 17 | 18 | 19 | 20 |
| Number of | 0 | 0 | 0 | 0 | 0 | 0 | 0 | 0 | 0 | 0 | 0 | 0 | 0 | 0 | 0 | 0 | 0 | 0 | 0 | 0 | 0 |
| Maintenance | 1 | 1 | 1 | 1 | 1 | 1 | 1 | 1 | 1 | 1 | 1 | 1 | 1 | 1 | 1 | 1 | 1 | 1 | 1 | 1 | 1 |
| Type Events | 2 | 2 | 2 | 2 | 2 | 2 | 2 | 2 | 2 | 2 | 2 | 2 | 2 | 2 | 2 | 2 | 2 | 2 | 2 | 2 | 2 |
| | 3 | 3 | 3 | 3 | 3 | 3 | 3 | 3 | 3 | 3 | 3 | 3 | 3 | 3 | 3 | 3 | 3 | 3 | 3 | 3 | 3 |
| | 4 | 4 | 4 | 4 | 4 | 4 | 4 | 4 | 4 | 4 | 4 | 4 | 4 | 4 | 4 | 4 | 4 | 4 | 4 | 4 | 4 |
| | 5 | 5 | 5 | 5 | 5 | 5 | 5 | 5 | 5 | 5 | 5 | 5 | 5 | 5 | 5 | 5 | 5 | 5 | 5 | 5 | 5 |
| | 6 | 6 | 6 | 6 | 6 | 6 | 6 | 6 | 6 | 6 | 6 | 6 | 6 | 6 | 6 | 6 | 6 | 6 | 6 | 6 | 6 |
| | 7 | 7 | 7 | 7 | 7 | 7 | 7 | 7 | 7 | 7 | 7 | 7 | 7 | 7 | 7 | 7 | 7 | 7 | 7 | 7 | 7 |
| | 8 | 8 | 8 | 8 | 8 | 8 | 8 | 8 | 8 | 8 | 8 | 8 | 8 | 8 | 8 | 8 | 8 | 8 | 8 | 8 | 8 |
| | 9 | 9 | 9 | 9 | 9 | 9 | 9 | 9 | 9 | 9 | 9 | 9 | 9 | 9 | 9 | 9 | 9 | 9 | 9 | 9 | 9 |
| | 10 | 10 | 10 | 10 | 10 | 10 | 10 | 10 | 10 | 10 | 10 | 10 | 10 | 10 | 10 | 10 | 10 | 10 | 10 | 10 | 10 |

| | | | | | | | | | | | | | | | | | | | | |
|---|---|---|---|---|---|---|---|---|---|---|---|---|---|---|---|---|---|---|---|---|
| Subtotal | 7 | 5 | 6 | 3 | 2 | 7 | 5 | 8 | 9 | 10 | 4 | 6 | 8 | 4 | 3 | 6 | 4 | 4 | 4 | 4 |

As depicted in the data represented in TABLE 1, the general competency module 118 plots a maximum number of ten maintenance type events (e.g., or tasks) against any relevant ATA2200 chapters associated with performing those events. For each of the ten maintenance type events, a scaled score of 0-10 is provided indicating a level of importance for each ATA2200 chapter as it applies to each of the events. The general competency module 118 provides a score of 10 to indicate a maximum level of general competence for a respective ATA2200 chapter and a score of 0 to indicate a lack of general competence for a respective ATA2200 chapter. The general competency module 118 can determine a total score based on the individual scores applied against each relevant chapters. For example, the total score for the chapter values for the events in TABLE 1 is 109. Once the total score is known, the general competency module 118 can calculate a percentage value of the total score out of a total maximum score (e.g., a score of 10 for each chapter). The calculated percentage represents the general competency score. For example, the percentage value for the values in TABLE 1 is 54.5% because the total score is 109 out of a maximum of 200. As would be appreciated by one skilled in the art, the maximum score will change based on a number of relevant chapters being considered for each task. For example, if two relevant ATA2200 chapters are to be considered for a particular task, position, or job than the maximum score available would be twenty, for three relevant ATA2200 chapters the maximum score available would be thirty and would continue upwards in multiples of ten.

In accordance with an example embodiment of the present invention, the general competence indication score is provided as a percentage of the maximum score available, depending on the number of relevant ATA2200 chapters to be considered. For example, if there are three relevant ATA2200 chapters (providing a max score of 30) and five events are identified as being associated with each chapter (totaling 15) then the general competence indication score would be 50% (15 events/30 max score). The higher the percentage scored, the higher the level of competence indicated. In accordance with an example embodiment of the present invention, the percentage score can further be broken down into levels of competency. For example, the possible scoring can be level 1 for percentages up to 20%, level 2 for percentages 20% and higher, level 3 for percentages 40% and higher, etc. Additionally, the number of relevant ATA2200 chapters will vary based on the engineer's role or a function/event being performed. In accordance with an example embodiment of the present invention, the relevant ATA2200 chapters will be set into groups by system 102 although and provided to clients or the clients may create their own relevant ATA2200 chapter groups as required to reflect the role being carried out by an individual. As would be appreciated by one skilled in the art, the relevant ATA2200 chapters can be stored, updated, and modified in the storage system 114 of the system 102 for use by the general competency module 118. For example, the relevant ATA2200 chapters can be stored in a database table format as represented by Reference TABLE 2.

TABLE 2
Aircraft General

| ATA Number | ATA Chapter Name | Mechanic | Elec./Avionic |
|---|---|---|---|
| ATA 05 | Time Limits/Maintenance | | |
| | Checks | | |
| ATA 06 | Dimensions and Areas | | |
| ATA 07 | Lifting and Shoring | 1 | |
| ATA 08 | Leveling and Weighing | 1 | 1 |
| ATA 09 | Towing and Taxi | 1 | 1 |
| ATA 10 | Parking, Mooring, Storage | 1 | 1 |
| | and Return to Service | | |
| ATA 11 | Placards and Markings | 1 | |
| ATA 12 | Servicing - Routing | 1 | 1 |
| | Maintenance | | |
| | Subtotal | 6 | 4 |

In particular, TABLE 2 depicts a table for general competency in “Aircraft General” as it applied to a mechanic and an electrical/avionic individual or employee. According to TABLE 2, the relevant ATA chapters for a mechanic individual or job role are identified as ATA 07, ATA 08, ATA 09, ATA 10, and ATA 11 and the relevant ATA chapters for an electrical/avionic individual or employee are identified as ATA 08, ATA 09, and ATA 10. TABLE 2 also indicates a sub total or total number of relevant ATA chapters for that position/task. For example, TABLE 2 depicts a sub total of six chapters for a mechanic and four chapters for an electrician/avionic. As would be appreciated by one skilled in the art, each position or function can include any number of tables to cover a variety of skills required of an individual or employee. Additionally, each position or skill set can include a predetermined combination of tables. For example, a mechanic and electric/avionic individual employ can also include relevant chapters as they relate to “Airframe Systems” each including 17 additional chapters, as depicted in TABLE 3.

TABLE 3
Aircraft General

| ATA Number | ATA Chapter Name | Mechanic | Elec./Avionic |
|---|---|---|---|
| ATA 20 | Standard Practices- | 1 | 1 |
| | Airframe | | |
| ATA 21 | Air Conditioning and | 1 | 1 |
| | Pressurization | | |
| ATA 22 | Autoflight | 1 | 1 |
| ATA 23 | Communications | 1 | 1 |
| ATA 24 | Electrical Power | 1 | 1 |
| ATA 25 | Equipment/Furnishings | 1 | 1 |
| ATA 26 | Fire Protection | 1 | 1 |
| ATA 27 | Flight Controls | 1 | 1 |
| ATA 28 | Fuel | 1 | 1 |
| ATA 29 | Hydraulic Power | 1 | 1 |
| ATA 30 | Ice and Rain Protection | 1 | 1 |
| ATA 31 | Indicating/Recording | 1 | 1 |
| | System | | |
| ATA 32 | Landing Gear | 1 | 1 |
| ATA 33 | Lights | 1 | 1 |
| ATA 34 | Navigation | 1 | 1 |
| ATA 35 | Oxygen | 1 | 1 |
| ATA 36 | Pneumatic | 1 | 1 |
| | Subtotal | 17 | 17 |

In accordance with an example embodiment of the present invention, a competency by task module 120 determines a level of competency for an individual to complete a particular task based on the experience records in their profile. For example, the competency by task module 120 can be used to evaluate a level of competency of an individual in replacing a main wheel on a Boeing 737, based on the data found in the experience record for the individual. An indication of individual task competence is calculated, by the competency by task module 120, by interrogating an individual's experience record from a preceding period of time. In particular, the competency by task module 120 searches the experience records for events matching criteria for the task to be carried out. The experience records can be checked against task criteria defined in the system 102, as shown in TABLE 4. Similarly, the task criteria shown in TABLE 4 can also be mapped to the relevant ATA2200 chapters. For example, the task of changing a main wheel on a Boeing 737 can checked against a criteria from the ATA2200 of Base Maintenance, Component Change, Boeing 737, 33-25-14, as shown in TABLE 4.

TABLE 4

| | Non- | | | | | |
|---|---|---|---|---|---|---|
| | Aircraft | | Manual | | Manual | Manual |
| | Type of | | Type, | | Type, | Type, |
| | Manual | | Aircraft | | Aircraft | Aircraft |
| Main- | Type | | Type | | Type | Type |
| tenance | Specific | Aircraft | and | Maintenance | and Sub | and |
| Type | Chapter | Type | Chapter | Activity | Chapter | Subject |
| Base | 33 | Boeing | 33 | Changing | 25 | 14 |
| Main- | | 737 | | Component | | |
| tenance | | | | | | |

In operation, the competency by task module 120 will extract a predetermined number of events (e.g., five) that most accurately match the criteria of the task details (e.g., presented in TABLE 4). When determining the score, the competency by task module 120 compares tasks from the experience record matching any of the criteria of the defined task (e.g., from TABLE 4) and rank the matches according the amount detail from the experience record that matches the criteria for the defined task. For example, the competency by task module 120 can search the experience record, matching the predetermined number of events (according to ATA2200 chapter, sub chapter or number of events) based on a level of detail matching a particular task using the ATA2200 chapter methodology standard. As would be appreciated by one skilled in the art, the interrogating, extracting, comparing, and ranking functions performed by the task module 120 can be executed utilizing any combination of methods or systems known in the art.

In accordance with an example embodiment of the present invention, the competency by task module 120 extracts the predetermined number of events by searching the experience records for events that match an exact level of detail for the defined task, then conduct a subsequent search while decreasing the level of detail by one category (chapter, sub-chapter, etc.) and continue the repeated search process while decreasing a level of detail for each subsequent search until one level of detail remains. For example, initially, the competency by task module 120 will search the experience record for tasks matching a detail level of all of the Maintenance Type, Non-specific Chapter, Aircraft Type, Specified Chapter, Maintenance Activity, Specified Sub Chapter and Specified Subject of the defined task, as defined by the system 102. After conducting the repeated search operations with decreasing levels of detail, the competency by task module 120 will search the experience record for tasks matching a detail level of all of the Maintenance Type, Non-specific Chapter, Aircraft Type, Specified Chapter, Maintenance Activity and Specified Sub Chapter. Next, the competency by task module 120 will search the experience record for tasks matching all of the Maintenance Type, Non-specific Chapter, Aircraft Type and Specified Chapter, and Maintenance Activity. Continuing with the example, the competency by task module 120 searches the experience record for tasks matching a detail level of all of the Maintenance Type, Non-specific Chapter, Aircraft Type, and Specified Chapter. Next, the competency by task module 120 searches the experience record for tasks matching all of the Maintenance Type, Non-specific Chapter, and Aircraft Type. Next, the competency by task module 120 will search the experience record for tasks matching a detail level of all of the Maintenance Type and Non-specific Chapter. Lastly, the competency by task module 120 will search the experience record for tasks matching just the Maintenance Type. Based on the search results in each of the above-noted steps, the competency by task module 120 can rank and identify the most detailed matching events and select the top predetermined number of events (e.g., the top five matched events with the greatest amount of detail). As would be appreciated by one skilled in the art, the competency by task module 120 can also search each permutation of the level of details or search according to the order of the defined task decrementing from right to left. Each level of detail is a field recorded in the experience record (e.g., ATA subject/event is the highest level of detail against an experience record).

Once the top predetermined number of events are identified by the competency by task module 120, the competency by task module 120 can plot the top matched predetermined number of events against an individual task scoring chart. The individual task scoring chart can be a weighted score chart based on a predetermined task criteria and the level of detail for the top predetermined number of events. For example, the individual task scoring chart depicted in TABLE 5 can be created by the competency by task module 120. As would be appreciated by one skilled in the art, the individual task scoring charts can be stored in the storage system 114 of the system 102 for use by the competency by task module 120.

TABLE 5
Experience Record Scoring Graph

| | | | | | | | |
|---|---|---|---|---|---|---|---|
| 5 | 8 | 13 | 21 | 34 | 55 | 89 | 144 |
| 4 | 5 | 8 | 13 | 21 | 34 | 55 | 89 |
| 3 | 3 | 5 | 8 | 13 | 21 | 34 | 55 |
| 2 | 2 | 3 | 5 | 8 | 13 | 21 | 34 |
| 1 | 1 | 2 | 3 | 5 | 8 | 13 | 21 |
| Events | Maintenance Type | Non- | Aircraft | Manual | Maintenance | Manual | Manual |
| | Base/Line/Workshop | Aircraft | Type | Type, | Activity | Type, | Type, |
| | | Type of | | Aircraft | | Aircraft | Aircraft |
| | | Manual | | Type | | Type, | Type, |
| | | Type | | and | | Chapter | Chapter, |
| | | Specific | | Chapter | | and | Sub |
| | | Chapter | | | | Sub | Chapter |
| | | | | | | Chapter | and |
| | | | | | | | Subject |

Low------------Level of Detail------------High

In particular, TABLE 5 depicts the weighted values provided by the competency by task module 120 based on a level of detail of the tasks from the experience records matching the searched defined tasks (e.g., task of TABLE 4). For example, if five tasks from an experience record match the full level of detail from the defined task (e.g., matching all of the Maintenance Type, Non-specific Chapter, Aircraft Type, Specified Chapter, Maintenance Activity, Specified Sub Chapter and Specified Subject) then the score would be 144. In another example, if an individual's experience record has recorded four events corresponding to the Maintenance Type, Non Specific Chapter, Aircraft Type, Specific Chapter and Maintenance Activity but also one event corresponding Maintenance Type, Non Specific Chapter, Aircraft Type, Specific Chapter, Maintenance Activity and Specific Sub Chapter, then using the TABLE 5, the score would be 47 (e.g., 34+13=47).

In accordance with an example embodiment of the present invention, the comparison against the individual task scoring chart also provides a score that can be taken as a percentage of a maximum total score. The percentage score will produce an indication of a level of competency for the individual task to be performed by the evaluated individual. The higher the percentage scored, the higher the level of competence. In accordance with an example embodiment of the present invention, the percentage score can further be broken down into levels of competency. For example, using the numbers from TABLE 5, the possible scoring can be level 1 for scores up to 13, level 2 for scores of 13 to 34, level 3 for scores of 34 to 84, and level 4 for scores 89 to 144. As depicted in TABLE 5, out of the top five events, the score can range from 1-144 based on a number of events matching a predetermined level of detail. For example, if the results of the searching and matching of the experience records is two events matching the middle level of detail (e.g., 8) and three events matching the highest level of detail (e.g., 55), then the score would be 63 (e.g., 8+55=63) out of a maximum potential of 144 which would provide a 43.75% percentage score.

In accordance with an example embodiment of the present invention, the system 102 also includes a recency module 122. The recency module 122 determines whether an individual satisfies a particular level of experience over a preceding period of time (e.g., a recent level of experience). Regulatory agencies may require that an individual have a certain amount of experience performing a particular task or position over a recent period of time and the recency module 122 is configured to track such information. In particular, the recency module 122 can check the experience records for particular tasks and the dates that the tasks were completed and determine whether those dates fall within the threshold period of time. In other words, recency module 122 can evaluate for recency based on duration of time and nature of an individual's experience, according to their experience records. For example, the recency module 122 can identify a number of events over a period of six months experience every two years and compare the results to the requirement standards (e.g., as per EASA Part 66). As would be appreciated by one skilled in the art, the six months can be six months working with the same organization or six months split up into different blocks, working within the same or in different organizations, or any combination thereof.

In accordance with an example embodiment of the present invention, the recency module 122 utilizes a table stored by the system 102 to manage the number of events and days hours over the predetermined period of time. TABLE 6 outlines example tables that may be formulated when the recency module 122 reports the events. In TABLE 6, the crosses denote the task(s) or events worked in the month concerned and the task(s) or events are then cross checked/evaluated against the predetermined six-month parameter in any two-year period to determine whether or not an individual has sufficient recent experience on an aircraft type.

TABLE 6
Aircraft Type

| | Man A | Man B | Man C | Man D | Man E | Man F | Man G | Man H | Man I |
|---|---|---|---|---|---|---|---|---|---|
| 1 | x | | | | | | | | |
| 2 | xx | | | | | | | | |
| 3 | | x | | | | x | | | |
| 4 | | | | | | x | | | |
| 5 | | | | | xx | | | | |
| 6 | x | | x | | xx | | | | |
| 7 | | | | | x | | | | |
| 8 | | | | | x | | | xxxxxx | |
| 9 | | | | | | | | | x |
| 10 | | | | | | | | | x |
| 11 | | | | | | x | | | x |
| 12 | xx | | | | | x | | | x |
| 13 | | | | x | | xx | | | x |
| 14 | | | | | | | | | x |
| 15 | | | | | | | xxxxx | | |
| 16 | | | | | | | | | |
| 17 | | | | | | | | | |
| 18 | | | | | | | | | |
| 19 | | | | | | | xx | | |
| 20 | x | x | | x | | | | | |
| 21 | | | | | | | | | |
| 22 | | | | | | | | | |
| 23 | | | | | | | | | |
| 24 | | | | | | | | | |
| | OK | OK | OK | OK | FAIL | FAIL | OK | FAIL | OK |

| | |
|---|---|
| | Period of association with an approved organization |
| x | Event |

As shown in TABLE 6, there are nine individuals (e.g., Man A-Man I) evaluated for recency by the recency module 122. Of the nine individuals shown in TABLE 6, three individuals were provided with a fail indication (e.g., Man E, Man F, and Man H) due to the period in which they carried out the events/task required to maintain recency (being less than the most recent six months) or because fewer events/tasks were undertaken necessary to recognize recency or the period was exceeded the six-month requirement to satisfy recency. For example, TABLE 6 depicts failure scores for individuals because the table accounts for a duration and nature of experience (e.g. at least a six-month period with an organization) not necessarily consecutive, but each consecutive period must have experience recorded in it.

In accordance with an example embodiment of the present invention, in the aviation industry, the recency module 122 provides recency scoring relevant to licensed engineers for licensed categories A, B1, B2, and C. To determine a recency score for an individual, the recency module 122 searches an individual's experience record for tasks/events carried out within the primary activities, specified license subcategory, and on the specified aircraft or similar aircraft within the last twenty-four months. In accordance with an example embodiment of the present invention, the recency module 122 considers license categories and subcategories of A1 and B1.1 Airplanes Turbine, A2 and B1.2 Airplanes Piston, A3 and B1.3 Helicopters Turbine, A4 and B1.4 Helicopters Piston, B2, and Category C. Additionally, the recency module 122 can consider primary activities of servicing, inspection, operational and functional testing, troubleshooting, repairing, modifying, changing component, supervising these activities, and releasing aircraft to service.

Additionally, the recency module 122 can check results to ensure tasks/events cover a six-month period associated to a maintenance organization via handshake (minimum of one event in the six month period). As would be appreciated by one skilled in the art, a handshake can include a request for a connection between two parties (e.g., a user and an organization) to access competence data that requires consent by both parties. As would be appreciated by one skilled in the art, the minimum of one task/event can be adjustable by the organization to reflect their company procedures. The recency module 122 can also check results to ensure tasks/events cover a total of six months over separate periods associated to different maintenance organizations via handshake (minimum of one event per period). As would be appreciated by one skilled in the art, the duration period may be adjustable by a quality department to allow for local CAA agreement regarding managers or low utilization aircraft in this illustrative example. The final indication of recency should be a “yes” or “no”, but also state the number of tasks/events and hours taken into consideration.

In accordance with an example embodiment of the present invention, the system 102 is accessed to provide business reporting. For example, the reports can include total staff employed versus contracted, companywide competence gap analysis, mandatory training, items that are current, due to expire, expired, and resource profile year on year, license, non-license, or the like. Additionally, the system 102 can be used to search task record, surname, forename, ATA or other regulatory standards chapter, task record, aircraft type license type or non-licensed work content. The system 102 can be used to identify validators task list, number of validations authorized or pending authorizations, task rejection, who, when, where, why, and five years of work experience and references to support, for example, the United Kingdom Department for Transport (DfT) and airport security clearance. The system 102 can also carry out reports that use algorithms to compare desired search criteria against a user or set of users' data to look at the number of tasks the users have entered that match their search criteria and attributing the highest score to the individuals with the greatest number of matching tasks, identify the individuals who have task records who most closely match the search criteria, attributing the highest score to the individuals who offer the closest match and the greatest number of matches, identify connected users who have the training and qualification standards that match the tasks identified in the search criteria, and identify users who have carried out enough tasks within a pre-defined time frame to qualify as being “recent”.

In accordance with an example embodiment of the present invention, the system 102 provides organizations and regulatory agencies with the ability to evaluate information for other purposes. For example, organizations and regulatory agencies can utilize system 102 to check competency of employees at different locations, when different regulations or standards are applied by the governing body. System 102 enables organizations to monitor and manage their personnel (e.g., engineers and non-engineers), carrying out comprehensive competency evaluations to ensure that teams are deployed effectively and that all technical staff are suitably skilled and qualified to be carrying out their roles. Used effectively system 102 has the potential to improve safety, efficiency, quality and internal training and development culture.

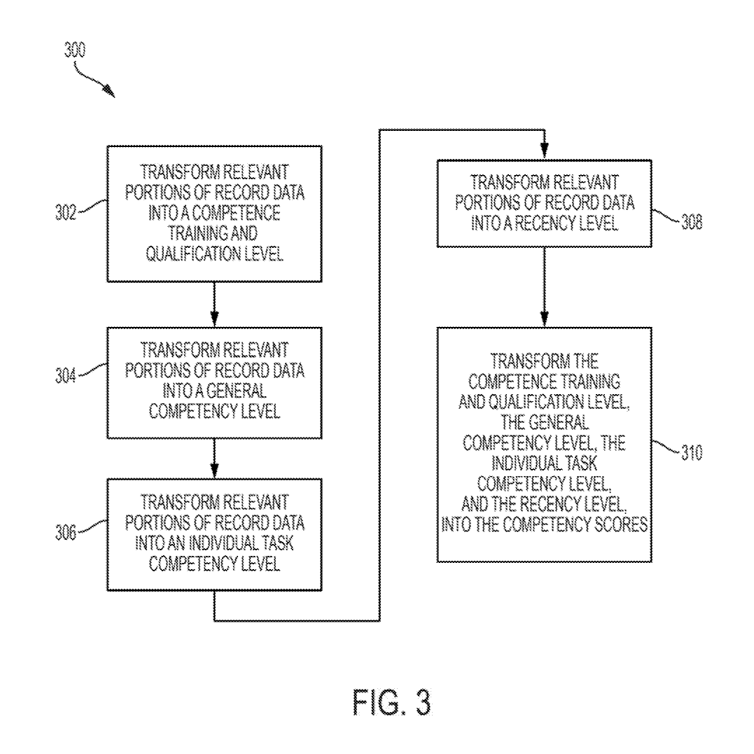

FIG. 3 shows exemplary flow charts depicting implementation of the present invention. Specifically, FIG. 3 depicts an exemplary flow chart showing the operation of the system 100, as discussed with respect to FIG. 1. In particular, FIG. 3 depicts how the system 102 transforms record data pertaining to an individual into a competency score for the individual for a particular task or position, as discussed with respect to FIG. 1. More specifically, FIG. 3 depicts how the system 102 assess competence by an evaluation and assessment of; training and qualifications, on competency assessments (e.g. on-the-job) and validated experience records, as required by the EASA Personnel competency requirements as defined by EASA Part 145.A.30(e). The modules 116, 118, 120, and 120 of the system 102 address all of these and provide competency scores to allow the organization to satisfy the regulatory requirements but are also flexible to enhance and enable risk-based oversight capability through the scoring mechanism. Additionally, the process 300 depicts how the system 102 quantifies a competency level of the individual based on the record data (e.g., experience records) pertaining to the individual.

At step 302, the system 102 transforms the relevant portions of the record data into a competence training and qualification level based on relevant training and qualification data for the individual for the particular task or position. The competence training and qualification level can be determined using the competence training and qualification assessment module 116, as discussed with respect to FIG. 1. The transformed competence training and qualification level can be stored in the storage system 114.

At step 304, the system 102 transforms the relevant portions of the record data into a general competency level of the individual based on at least one predetermined industry standard data (e.g., ATA2200 chapter methodology). The general competency level can be determined using the general competency module 118, as discussed with respect to FIG. 1. The transformed general competency level can be stored in the storage system 114.

At step 306, the system 102 transforms the relevant portions of the record data into an individual task competency level of the individual for the particular task or position based on the relevant training and qualification data of particular completed tasks performed by the individual. The individual task competency level can be determined using the competency by task module 120, as discussed with respect to FIG. 1. The transformed individual task competency level can be stored in the storage system 114.

At step 308, the system 102 transforms the relevant portions of the record data into a recency level based on duration and nature of experience data within a predetermined historical time period. The recency level can be determined using the recency module 122, as discussed with respect to FIG. 1. The transformed recency level can be stored in the storage system 114.

At step 310, the system 102 transforms the competence training and qualification level, the general competency level, the individual task competency level, and the recency level, into the competency scores of the individual. As would be appreciated by one skilled in the art, the competency scores can be a single overall score or it can be a combination of scores for each individual transformed level. The transformed competency scores of the individual can be output using a display device known in the art (e.g., over I/O device 112 and/or on user device(s) 124). Additionally, at step 310, the system 102 can provide the scores in a summary to a user (e.g., via the user interface).

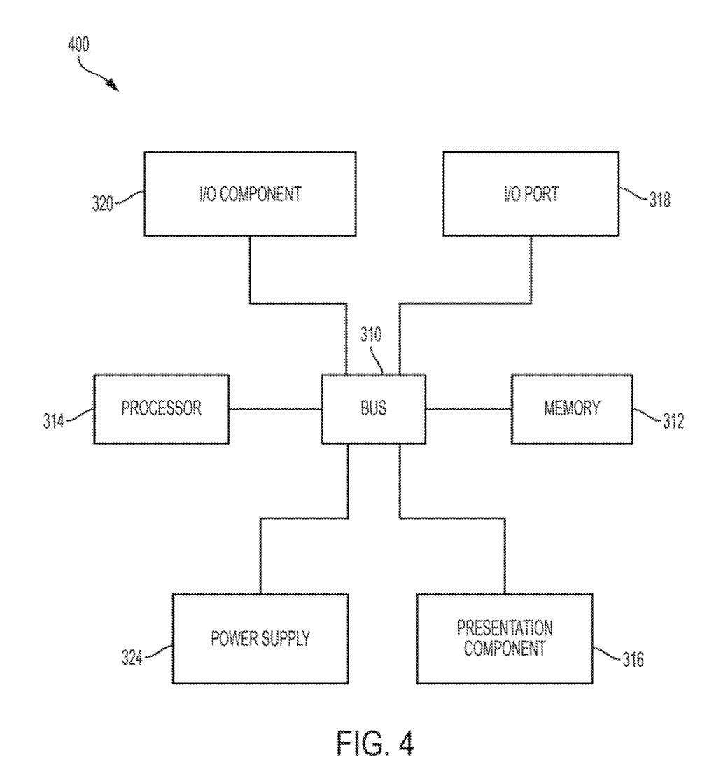

Any suitable computing device can be used to implement the computing devices 102, 104, 124 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 400 is depicted in FIG. 4. The computing device 400 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 400 is depicted for illustrative purposes, embodiments of the present invention may utilize any number of computing devices 400 in any number of different ways to implement a single embodiment of the present invention. Accordingly, embodiments of the present invention are not limited to a single computing device 400, as would be appreciated by one with skill in the art, nor are they limited to a single type of implementation or configuration of the example computing device 400.

The computing device 400 can include a bus 310 that can be coupled to one or more of the following illustrative components, directly or indirectly: a memory 312, one or more processors 314, one or more presentation components 316, input/output ports 318, input/output components 320, and a power supply 324. One of skill in the art will appreciate that the bus 310 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 400 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 400.

The memory 312 can include computer-storage media in the form of volatile and/or nonvolatile memory. The memory 312 may be removable, non-removable, or any combination thereof. Exemplary hardware devices are devices such as hard drives, solid-state memory, optical-disc drives, and the like. The computing device 400 can include one or more processors that read data from components such as the memory 312, the various I/O components 316, etc. Presentation component(s) 316 present data indications to a user or other device. Exemplary presentation components include a display device, speaker, printing component, vibrating component, etc.

The I/O ports 318 can enable the computing device 400 to be logically coupled to other devices, such as I/O components 320. Some of the I/O components 320 can be built into the computing device 400. Examples of such I/O components 320 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method, comprising:
quantifying, using at least one processor, a competency level of the individual based on record data pertaining to the individual, the process of quantifying comprising:
transforming relevant portions of the record data, using at least one processor, into a competence training and qualification level based on relevant training and qualification data for the individual for the particular task or position, and storing the competence training and qualification level;
transforming relevant portions of the record data, using at least one processor, into a general competency level of the individual based on at least one predetermined industry standard data, and storing the general competency level;
transforming relevant portions of the record data, using at least one processor, into an individual task competency level of the individual for the particular task or position based on the relevant training and qualification data of particular completed tasks performed by the individual; and
transforming relevant portions of the record data, using at least one processor, into a recency level based on duration and nature of experience data within a predetermined historical time period;
transforming, using the at least one processor, the competence training and qualification level, the general competency level, the individual task competency level, and the recency level, into the competency scores of the individual; and
outputting the competency scores of the individual in such a way that record data pertaining to an individual is transformed into output competency scores for the individual for a particular task, position, or job role.

2. The method of claim 1, wherein the relevant training and qualification data comprises details related to work history qualifications, training, and work experience of the individuals.

3. The method of claim 1, wherein transforming the competence training and qualification level comprises searching the record data of the individuals for specific qualifications and training certificates related to the particular task or position.

4. The method of claim 3, wherein a result of transforming the competence training and qualification level comprises a pass or fail indication.

5. The method of claim 1, wherein transforming the general competency level comprises searching the record data and comparing aptitude and experience information over a period of time against a predetermined competency criteria.

6. The method of claim 5, wherein transforming the general competency level further comprises plotting a result of the searching and comparing against the at least one predetermined industry standard data to create a general competency score.

7. The method of claim 1, wherein transforming the individual task competency level comprises interrogating the record data for aptitude and experience information related to the particular task or position.

8. The method of claim 7, wherein a predetermined number of relevant training and qualification data related to the particular task or position is plotted against an experience record scoring graph to create an individual task competency score.

9. The method of claim 1, wherein transforming the recency level comprises evaluating the duration and nature of aptitude and experience of the individuals based on the relevant training and qualification data.

10. A system, comprising:
an input device configured to receive one or more profiles associated with the individuals, the one or more profiles including record data containing aptitude and experience information for the individuals;
a quantifying tool configured to determine a competency level of the individual based on the received one or more profiles, the process of quantifying comprising:
a competence training and qualification assessment module configured to transform relevant portions of the record data into a competence training and qualification level based on relevant training and qualification data for the individual for the particular task or position, and storing the competence training and qualification level;
a general competency module configured to transform relevant portions of the record data into a general competency level of the individual based on at least one predetermined industry standard data, and storing the general competency level;
an individual task competency module configured to transform relevant portions of the record data into an individual task competency level of the individual for the particular task or position based on the relevant training and qualification data of particular completed tasks performed by the individual; and
a recency module configured to transform relevant portions of the record data into a recency level based on duration and nature of experience data within a predetermined historical time period;
the quantifying tool transforms the competence training and qualification level, the general competency level, the individual task competency level, and the recency level, into the competency scores of the individual; and
a display device configured to output the competency scores of the individual.

11. The system of claim 10, wherein the relevant training and qualification data comprises details related to work history qualifications, training, and work experience of the individuals.

12. The system of claim 10, wherein transforming the competence training and qualification level comprises searching the one or more profiles of the individuals for specific qualifications and training certificates related to the particular task or position.

13. The system of claim 12, wherein a result of transforming the competence training and qualification level comprises a pass or fail indication.

14. The system of claim 10, wherein transforming the general competency level comprises searching the one or more profiles and comparing aptitude and validated electronic logbook experience information over a period of time against a predetermined competency criteria.

15. The system of claim 14, wherein transforming the general competency level further comprises plotting a result of the searching and comparing against the at least one predetermined industry standard data to create a general competency score.

16. The system of claim 10, wherein transforming the individual task competency level comprises interrogating the one or more profiles for aptitude validated electronic logbook and experience information related to the particular task or position.

17. The system of claim 16, wherein a predetermined number of relevant training and qualification data related to the particular competency, task, position, or job role is plotted against an experience record scoring graph to create an individual task competency score.

18. The system of claim 16, wherein information in the one or more profiles is validated by a user that has been granted the relevant privileges and/or permissions.

19. The system of claim 16, wherein the experience information is validated, when a user uploads experience record data, by selecting a validator that has been granted the relevant privileges and/or permissions.

20. The system of claim 10, wherein transforming the recency level includes evaluating the duration, nature, and frequency of validated electronic logbook experience of the individuals based on the industry standard requirement data.
